(19) United States
(12) Patent Application Publication
(10) Pub. No.: US 2016/0037601 A1
(43) Pub. Date: Feb. 4, 2016

(54) BACKLIGHT DEVICE

(71) Applicant: Sharp Kabushiki Kaisha, Osaka-shi, Osaka (JP)

(72) Inventors: Xiaomang ZHANG, Osaka-shi (JP); Toshihiro YANAGI, Osaka-shi (JP); Takae ITOU, Osaka-shi (JP); Hideki MORII, Osaka-shi (JP); Takayuki MIZUNAGA, Osaka-shi (JP)

(21) Appl. No.: 14/776,920

(22) PCT Filed: Feb. 19, 2014
(86) PCT No.: PCT/JP2014/053953

§ 371 Date: Sep. 15, 2015

(30) Foreign Application Priority Data
Mar. 19, 2013 (JP) 2013-056734

(51) Int. Cl. H05B 33/08

(52) U.S. Cl. CPC H05B 33/0824

(57) ABSTRACT

A backlight device that achieves high efficiency for a plurality of input voltages includes: a converter circuit; a first light-emitting element column and a second light-emitting element column each including one or more light-emitting elements connected in series; and a group of switches configured to control electrical connection between the converter circuit, the first light-emitting element column and the second light-emitting element column, wherein the group of switches are switched between a plurality of connection states including a first connection state in which the first light-emitting element column and the second light-emitting element column are in series and connected with the converter circuit and a second connection state in which the first light-emitting element column and the second light-emitting element column are in parallel and connected with the converter circuit.

### TECHNICAL FIELD

The present invention relates to a backlight device, and, more particularly, to a backlight device including a converter circuit.

### BACKGROUND ART

In recent years, the resolution of display devices of portable devices, such as notebook PCs and tablets, has been increasing. Since a display device with higher resolution has a lower transmittance, its backlight must have a higher luminance. A backlight with higher luminance means that the backlight device requires higher power consumption.

To reduce the power consumption of backlight devices, backlight devices using light-emitting diodes (LEDs) are used.

JP 2012-133937 A describes an LED backlight device where a constant direct current flows into a plurality of LED strings and the same current level is supplied even when the LED strings receive different forward voltages.

### DISCLOSURE OF THE INVENTION

In a device including a backlight device, a plurality of power supplies with different voltages may be used, where the voltages are converted by a converter circuit before being used. For example, in a portable device, an external power supply and a battery may be used as its power supply. Further, if a battery is used as the power supply, the input voltage may vary as the battery is drained. If a device is designed so as to handle a wide range of input voltage, the efficiency of the converter circuit typically decreases and the efficiency of the backlight device typically decreases, too.

An object of the present invention is to provide a backlight device that provides high efficiency for a plurality of input voltages.

A backlight device disclosed herein includes: a converter circuit; a first light-emitting element column and a second light-emitting element column each including one or more light-emitting elements connected in series; and a group of switches configured to control electrical connection between the converter circuit, the first light-emitting element column and the second light-emitting element column. The group of switches are switched between a plurality of connection states including a first connection state in which the first light-emitting element column and the second light-emitting element column are in series and connected with the converter circuit and a second connection state in which the first light-emitting element column and the second light-emitting element column are in parallel and connected with the converter circuit.

The present invention provides a backlight device that provides high efficiency for a plurality of input voltages.

### BRIEF DESCRIPTION OF THE DRAWINGS

FIG. 1 is a functional block diagram of a portable device including a backlight device in a first embodiment of the present invention.

FIG. 2 is a schematic diagram of an LCD module.

FIG. 3 is an equivalent circuit schematic of those of the components of the portable device that are involved in lighting of the light source, where the external power supply is selected as the power supply.

FIG. 4 illustrates the switch group S1 of FIG. 3.

FIG. 5 illustrates a specific example construction of the switch S1-1.

FIG. 6 illustrates the switch group S2 of FIG. 3.

FIG. 7 illustrates a specific example construction of the switch S2-1.

FIG. 8 illustrates the switch group S3 of FIG. 3.

FIG. 9 illustrates a specific example construction of the switch S3-1.

FIG. 10 is an equivalent circuit schematic of those of the components of the portable device that are involved in lighting of the light source, where the built-in battery is selected as the power supply.

FIG. 11 is an equivalent circuit schematic of those of the components of a portable device including a backlight device in an example variation of the first embodiment of the present invention that are involved in lighting of the light source.

FIG. 12 illustrates the other connection state of the switch groups of the portable device in the present example variation.

FIG. 13 is an equivalent circuit schematic of those of the components of a portable device including a backlight device in another example variation of the first embodiment of the present invention that are involved in lighting of the light source.

FIG. 14 illustrates one connection state of the switch groups of the portable device in the other example variation of the first embodiment of the present invention.

FIG. 15 illustrates another connection state of the switch groups of the portable device in the other example variation of the first embodiment of the present invention.

FIG. 16 illustrates yet another connection state of the switch groups of the portable device in the other example variation of the first embodiment of the present invention.

FIG. 17 is an equivalent circuit schematic of those of the components of a portable device including a backlight device in a second embodiment of the present invention that are involved in lighting of the light source.

FIG. 18 is an equivalent circuit schematic of those of the components of a portable device including a backlight device in a third embodiment of the present invention that are involved in lighting of the light source.

### EMBODIMENTS FOR CARRYING OUT THE INVENTION

A backlight device in an embodiment of the present invention includes: a converter circuit; a first light-emitting element column and a second light-emitting element column each including one or more light-emitting elements connected in series; and a group of switches configured to control electrical connection between the converter circuit, the first light-emitting element column and the second light-emitting element column. The group of switches are switched between a plurality of connection states including a first connection state in which the first light-emitting element column and the second light-emitting element column are in series and connected with the converter circuit and a second connection state in which the first light-emitting element column and the second light-emitting element column are in parallel and connected with the converter circuit (first arrangement).

In the above arrangement, the group of switches switch the first and second light-emitting element columns, which form loads, between different connection states, thereby changing the voltage required to drive them. More specifically, the voltage required to drive the first and second light-emitting element columns in the second connection state, in which the first and second light-emitting element columns in parallel are connected with the converter circuit, is smaller than that in the first connection state, in which the first and second light-emitting element columns in series are connected with the converter circuit.

A converter converts an input voltage to (voltage of load/input voltage) times the input voltage. If the configuration of the load is fixed and only the input voltage varies, the conversion rate of the converter also varies. Typically, a converter that is designed to handle a wide range of conversion rate has lower efficiency. In the above arrangement, the configuration of the load can be switched such that the range of conversion rate to be handled by the converter can be reduced over conventional implementations. This allows a converter circuit with higher efficiency to be used, thereby increasing the efficiency of the backlight device.

Starting from the first arrangement, a signal generating circuit may be further included that is configured to receive a signal related to a value of an input voltage supplied to the converter circuit, and switch the group of switches to the first connection state when the input voltage is not lower than a predetermined value, and switch the group of switches to the second connection state when the input voltage is lower than the predetermined value (second arrangement).

Starting from the first arrangement, a signal generating circuit may be further included that is configured to receive a signal related to a type of a power supply supplying power to the converter circuit, and switch the group of switches between the first connection state and the second connection state depending on the type of the power supply (third arrangement).

Starting from the third arrangement, the signal generating circuit may switch the group of switches to the first connection state when the type of the power supply is external power supply and switch the group of switches to the second connection state when the type of the power supply is battery (fourth arrangement).

Starting from one of the first to fourth arrangements, a number of the light-emitting elements included in the first light-emitting element column may be equal to a number of the light-emitting elements included in the second light-emitting element column (fifth arrangement).

Starting from one of the first to fourth arrangements, a number of the light-emitting elements included in the first light-emitting element column may be different from a number of the light-emitting elements included in the second light-emitting element column (sixth arrangement).

Starting from one of the first to sixth arrangements, a third light-emitting element column may be further included that includes one or more light-emitting elements connected in series, wherein, in the first connection state, the group of switches connect the first light-emitting element column, the second light-emitting element column and the third light-emitting element column in series and with the converter circuit (seventh arrangement).

Now, embodiments of the present invention will be described in detail with reference to the drawings. In the drawings, the same or corresponding components are labeled with the same characters and their description will not be repeated. For ease of explanation, in the drawings to which reference will be made below, the components may be shown in a simplified or schematic manner, or some components may not be shown. Further, the size ratios of the components shown in the drawings do not necessarily represent the actual size ratios.

### First Embodiment

FIG. 1 is a functional block diagram of a portable device 1 including a backlight device in a first embodiment of the present invention. The portable device 1 includes a body 100 and an AC adaptor 10. The body 100 contains a built-in battery 20, a liquid crystal display (LCD) module 30, a mother board 40, and a power supply selecting switch K.

The portable device 1 selects a power supply from among an external power supply and built-in battery 20 and uses the selected power supply. In the portable device 1, for example, when the AC adaptor 10 is connected to an external power supply, the power supply selecting switch K is switched to the contact K1 such that power is supplied to the LCD module 30 and mother board 40 from the external power supply via the AC adaptor 10. When the AC adaptor 10 is disconnected from the external power supply, the power supply selecting switch K is switched to the contact K2 such that power is supplied to the LCD module 30 and mother board 40 from the built-in battery 20.

The mother board 40 controls the entire portable device 1 by driving the LCD module 30 as well as an input/output device, calculation device and other components, not shown.

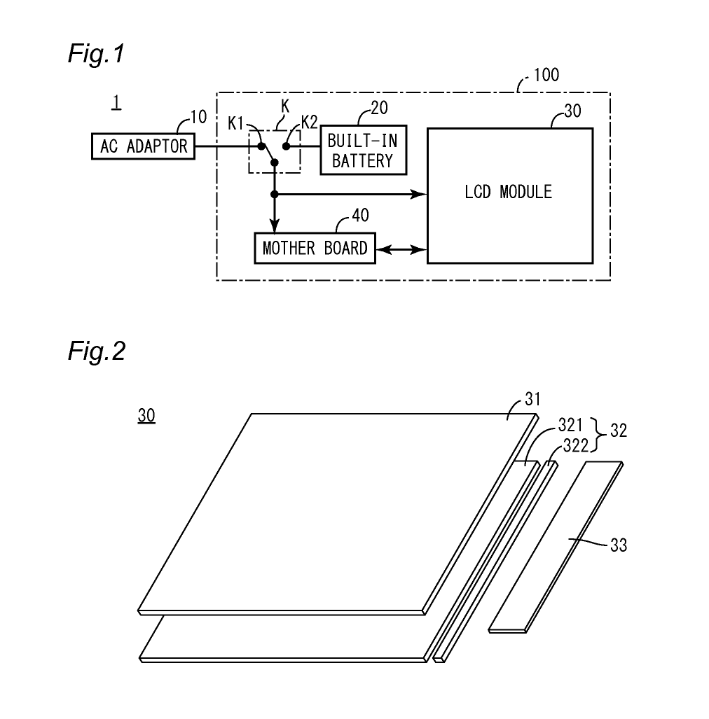

FIG. 2 is a schematic diagram of an LCD module 30. The LCD module 30 includes a liquid crystal display panel 31, a backlight device 32 and a control board 33.

Although not shown in detail, the liquid crystal display panel 31 includes two substrates and a liquid crystal layer filled between the two substrates. The liquid crystal display panel 31 controls the orientation of liquid crystal molecules in the liquid crystal layer to adjust the transmittance of light directed from the backlight device 32 on a pixel-by-pixel basis, thereby displaying a desired image.

The backlight device 32 includes a light guide 321 and a light source 322. Although not shown in FIG. 2, the backlight device 32 includes, in addition, optical sheets such as a reflection sheet, a diffusion sheet and a lens sheet.

The light guide 321 is generally shaped as a plate and includes a pattern of dots on its surface. The light source 322 is positioned along one side of the light guide 321 and illuminates this side with light. Light that has entered the light guide 321 travels through the interior of the light guide 321 while being totally reflected, and is scattered by the dot pattern and exits the light guide 321. Thus, uniform light is directed to the liquid crystal display panel 31 from the surface of the light guide 321. That is, the backlight device 32 shown in FIG. 2 is a so-called edge-lit backlight device. This configuration is merely an example and the backlight device 32 may be a so-called direct-lit backlight device.

The control board 33 is connected with the liquid crystal display panel 31 and backlight device 32 via a flexible printed circuit (FPC), for example. The control board 33 generates timing signals, transfers display data and perform other operations to display an image on the liquid crystal display panel 31.

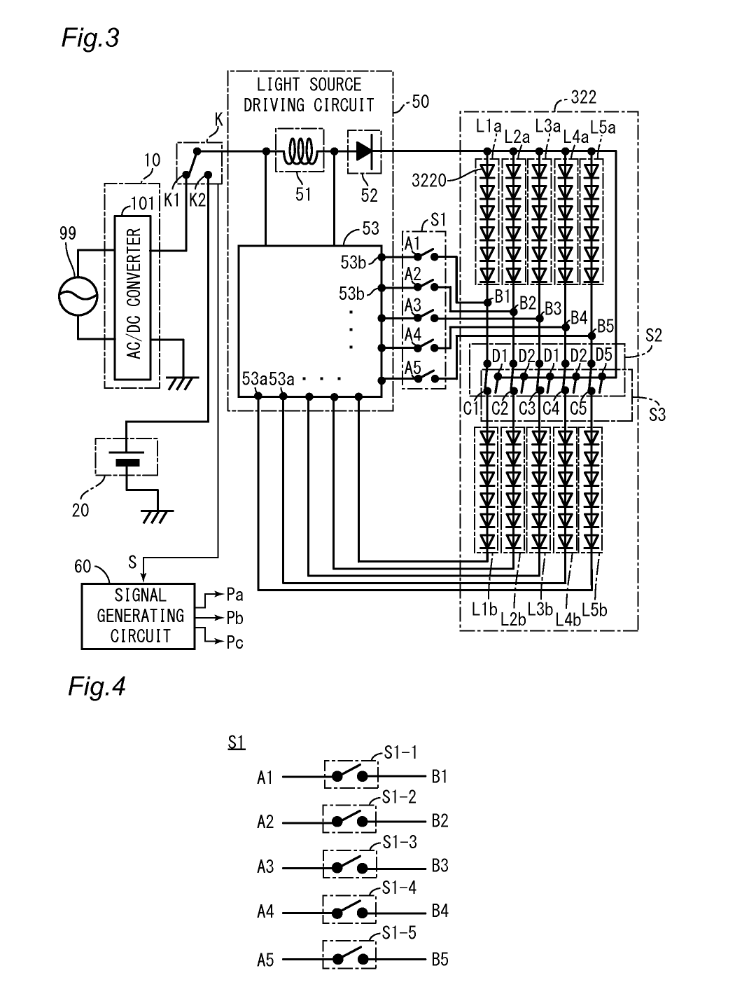

FIG. 3 is an equivalent circuit schematic of those of the components of the portable device 1 that are involved in lighting of the light source 322. The portable device 1 includes, in addition to the components shown in FIG. 1, a light source driving circuit (i.e. converter circuit) 50, a signal generating circuit 60, and switch groups S1, S2 and S3.

The light source driving circuit 50 receives power from one power source selected from among the external power supply 99 and built-in battery 20, boosts its voltage to a predetermined level and supplies it to the light source 322. The power from the external power supply 99 is converted to a direct current by an AC/DC converter 101 in the AC adaptor 10, and is supplied to the light source driving circuit 50.

The signal generating circuit 60 generates signals Pa, Pb and Pc and supplies them to the switch groups S1, S2 and S3. The switch groups S1, S2 and S3 operate based on the signals Pa, Pb and Pc. In the present embodiment, the signal generating circuit 60 receives, from the power supply selecting switch K, a signal S related to the type of the selected power supply, and generates the signals Pa, Pb and Pc based on the signal S. The behavior of the signals Pa, Pb and Pc, as well as the operation of the switch groups S1, S2 and S3 will be described further below.

The light source driving circuit 50 and signal generating circuit 60 may be mounted on the mother board 40 (FIG. 1), or may be mounted on the control board 33 (FIG. 2).

The present invention does not limit the light source driving circuit 50 to a particular type. Although an example configuration of the light source driving circuit 50 will be described below, this is merely an example and the light source driving circuit 50 may have any configuration.

The light source driving circuit 50 includes an inductor 51, a rectifier 52 and a switching integrated circuit (IC) 53. The switching IC 53 includes switching elements for switching at a predetermined frequency. When the switching elements are on, the light source driving circuit 50 causes the inductor 51 to accumulate energy, and, when the switching elements are off, it causes the inductor 51 to generate an electromotive force. The light source driving circuit 50 adjusts the ratio between the lengths of the on period and off period to convert an input voltage to a desired level for an output voltage.

The switching IC 53 includes a plurality of output terminals 53a and 53b. The switching IC 53 ensures that currents flowing through the loads connected with the output terminals 53a and 53b are constant.

The light source 322 includes light-emitting element columns (i.e. first light-emitting element column) L1a, L2a, . . . , and L5a, and light-emitting element columns (i.e. second light-emitting element column) L1b, L2b, . . . , and L5b. Each of the light-emitting element columns L1a, L2a, . . . , and L5a and light-emitting element columns L1b, L2b, . . . , and L5b includes six light-emitting elements 3220 connected in series. The light-emitting elements 3220 may be LEDs, for example.

FIG. 3 shows an electrical configuration and is not related to the spatial arrangement of the light-emitting element columns L1a, L2a, . . . , and L5a and light-emitting element columns L1b, L2b, . . . , and L5b, or the spatial arrangement of the light-emitting elements 3220. These element columns or elements may be in any spatial arrangement.

The switch groups S1, S2 and S3 are located between the light source driving circuit 50, light-emitting element columns L1a, L2a, . . . , L5a and light-emitting element columns L1b, L2b, . . . , and L5b for switching their electrical connection between different states.

FIG. 4 illustrates the switch group S1 of FIG. 3. The switch group S1 includes switches S1-1, S1-2, . . . , and S1-5. The switch S1-1 switches the electrical connection between the points A1 and B1. That is, it switches the electrical connection between the cathode of the light-emitting element column L1a and the output terminal 53a of the switching IC 53. Similarly, the switch S1-2 switches the electrical connection between the points A2 and B2, the switch S1-3 switches the electrical connection between the points A3 and B3, the switch S1-4 switches the electrical connection between the points A4 and B4, and the switch S1-5 switches the electrical connection between the points A5 and B5.

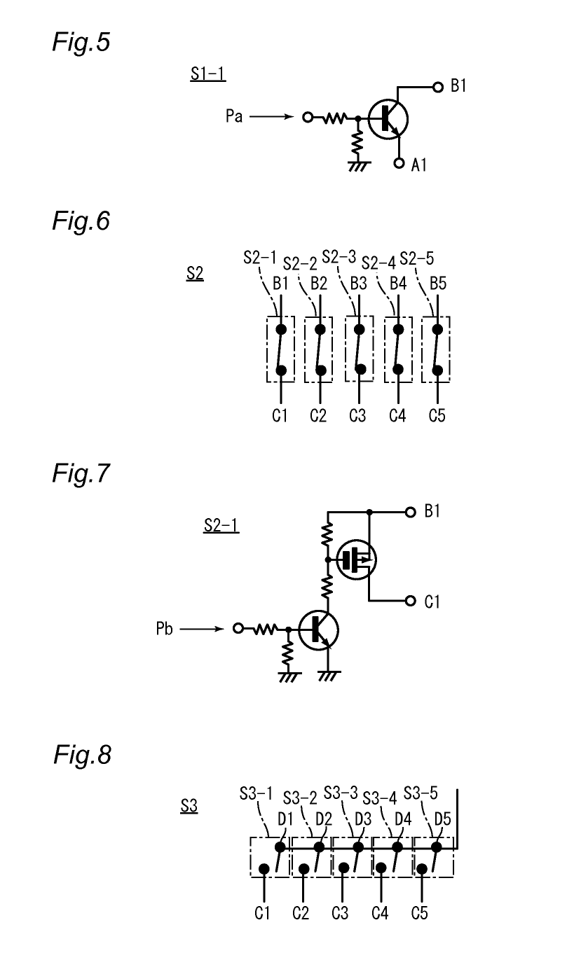

FIG. 5 illustrates a specific example construction of the switch S1-1. The switch S1-1 is located closer to the ground than its associated load (i.e. light-emitting element column L1a) is, and thus may be implemented by a low-side switch circuit shown in FIG. 5. The switch S1-1 receives the signal Pa from the signal generating circuit 60. The signal Pa is a logic signal where the switch S1-1 is on (i.e. the points A1 and B1 are electrically connected) when Pa=1, and the switch S1-1 is off (i.e. the points A1 and B1 are not electrically connected) when Pa=0. The switches S1-2 to S1-5 may have the same configuration.

FIG. 6 illustrates the switch group S2 of FIG. 3. The switch group S2 includes switches S2-1, S2-2, . . . , and S2-5. The switch S2-1 switches the electrical connection between the points B1 and C1. That is, it switches the electrical connection between the cathode of the light-emitting element column L1a and the anode of the light-emitting element column L1b. Similarly, the switch S2-2 switches the electrical connection between the points B2 and C2, the switch S2-3 switches the electrical connection between the points B3 and C3, the switch S2-4 switches the electrical connection between the points B4 and C4, and the switch S2-5 switches the electrical connection between the points B5 and C5.

FIG. 7 illustrates a specific example construction of the switch S2-1. The switch S2-1 is located farther from the ground than its associated load (i.e. light-emitting element column L1b) is, and thus may be implemented by a high-side switch circuit shown in FIG. 7. The switch S2-1 receives the signal Pb from the signal generating circuit 60. The signal Pb is a logic signal where the switch S2-1 is on (i.e. the points B1 and C1 are electrically connected) when Pb=1, and the switch S2-1 is off (i.e. the points B1 and C1 are not electrically connected) when the Pb=0. The switches S2-2 to S2-5 may have the same configuration.

FIG. 8 illustrates the switch group S3 of FIG. 3. The switch group S3 includes switches S3-1, S3-2, . . . , and S3-5. The switch S3-1 switches the electrical connection between the points C1 and D1. That is, it switches the electrical connection between the anode of the light-emitting element column L1b and the cathode of the rectifier 52. Similarly, the switch S3-2 switches the electrical connection between the points C2 and D2, the switch S3-3 switches the electrical connection between the points C3 and D3, the switch S3-4 switches the electrical connection between the points C4 and D4, and the switch S3-5 switches the electrical connection between the points C5 and D5.

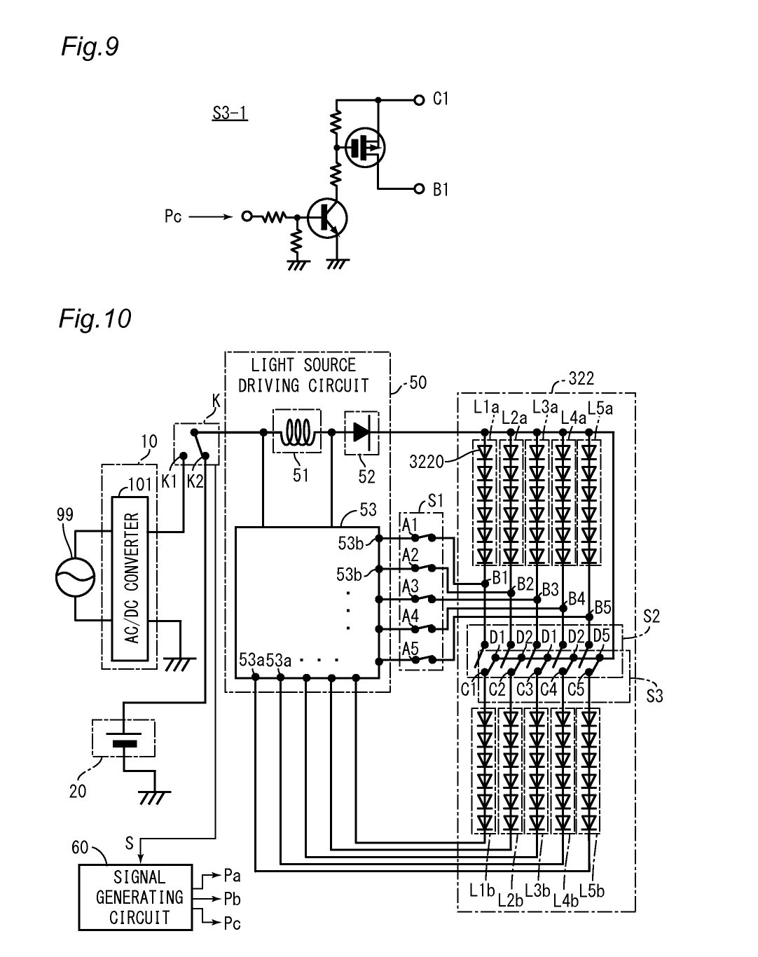

FIG. 9 illustrates a specific example construction of the switch S3-1. The switch S3-1 is located farther from the ground than its associated load (i.e. light-emitting element column L1b) is, and thus may be implemented by a high-side switch circuit shown in FIG. 9. The switch S3-1 receives the signal Pc from the signal generating circuit 60. The signal Pc is a logic signal where the switch S3-1 is on (i.e. the points C1 and D1 are electrically connected) when Pc=1, and the switch S3-1 is off (i.e. the points C1 and D1 are not electrically connected) when Pc=0. The switches S3-2 to S3-5 may have the same configuration.

As discussed above, the signal generating circuit 60 generates the signals Pa, Pb and Pc based on the signal S sent by the power supply selecting switch K. In other words, the switch groups S1, S2 and S3 are switched between different connection states together with the power supply selecting switch K.

The signal S is a logic signal where S=0 when the external power supply 99 is selected as the power supply, for example, and S=1 when the built-in battery 20 is selected as the power supply. In the present embodiment, the signal generating circuit 60 generates the signals Pa, Pb and Pc according to the following equation:

Pa=S, Pb= S̅, Pc=S [Equation 1]

Here, a bar above a character in the equation means a NOT operation. That is, the signal generating circuit 60 generates the signals Pa, Pb and Pc such that Pa=0, Pb=1 and Pc=0 when S=0, and Pa=1, Pb=0 and Pc=1 when S=1.

Returning to FIG. 3, which shows the state found when the external power supply 99 is selected as the power supply, all the switches S1-1, S1-2, . . . , and S1-5 of the switch group S1 are off, all the switches S2-1, S2-2, . . . , and S2-5 of the switch group S2 are on, and all the switches S3-1, S3-2, . . . , and S3-5 of the switch group S3 are off.

Thus, the light-emitting element column L1a and light-emitting element column L1b are in series and connected with the light source driving circuit 50. This is equivalent to a light-emitting element column formed by twelve light-emitting elements 3220 in series being connected with the light source driving circuit 50. Similarly, the light-emitting element column L2a and light-emitting element column L2b in series, the light-emitting element column L3a and light-emitting element column L3b in series, the light-emitting element column L4a and light-emitting element column L4b in series, and the light-emitting element column L5a and light-emitting element column L5b in series are connected with the light source driving circuit 50.

That is, in FIG. 3, five light-emitting element columns each composed of twelve light-emitting elements 3220 are in parallel and connected with the light source driving circuit 50.

FIG. 10 shows the state found when the built-in battery 20 is selected as the power supply. In this state, all the switches S1-1, S1-2, . . . , and S1-5 of the switch group S1 are on, all the switches S2-1, S2-2, . . . , and S2-5 of the switch group S2 are off, and all the switches S3-1, S3-2, . . . , and S3-5 of the switch group S3 are on.

Thus, in FIG. 10, all the light-emitting element columns L1a, L2a, . . . , and L5a and light-emitting element columns L1b, L2b, . . . , and L5b are in parallel and connected with the light source driving circuit 50.

That is, in FIG. 10, ten light-emitting element columns each composed of six light-emitting elements 3220 are in parallel and connected with the light source driving circuit 50.

### Effects of First Embodiment

As discussed above, in the state of FIG. 3, five light-emitting element columns each composed of twelve light-emitting elements 3220 are in parallel and connected with the light source driving circuit 50. For example, supposing that the voltage required to light one light-emitting element 3220 is 3 volts, the voltage required to light a light-emitting element column having twelve light-emitting elements 3220 connected in series is 36 volts.

On the other hand, in the state of FIG. 10, ten light-emitting element columns each composed of six light-emitting elements 3220 are in parallel and connected with the light source driving circuit 50. The voltage required to light a light-emitting element column having six light-emitting elements 3220 connected in series is 18 volts.

It is assumed that the voltage output from the AC adaptor 10 is 20 volts and the voltage output from the built-in battery 20 is 10 volts. If the switch groups S1, S2 and S3 remained in the connection state of FIG. 3, the boosting ratio (i.e. output voltage/input voltage) of the light source driving circuit 50 would be 1.8 with the AC adaptor 10 used as the power supply, and would be 3.6 with the built-in battery 20 used as the power supply. If this wide range of boosting ratio is to be covered, the efficiency of the light source driving circuit 50 typically decreases. Further, the higher the boosting ratio, the more likely the efficiency of the light source driving circuit 50 decreases. A decrease in the efficiency of the light source driving 50 may increase power consumption and cause the light source driving circuit 50 to heat up.

In the present embodiment, the switch groups S1, S2 and S3 are switched between different connection states depending on the type of the power supply being selected. More specifically, when the external power supply 99 is selected as the power supply, this results in the connection state of FIG. 3 (i.e. first connection state); when the built-in battery 20 is selected as the power supply, this results in the connection state of FIG. 10 (i.e. second connection state). In either case, the boosting ratio of the light source driving circuit 50 is 1.8.

Thus, in the present embodiment, the configuration of the light-emitting element columns, which form loads, may be switched to adjust the voltage required to light the light-emitting element columns. This reduces variations in the boosting ratio of the light source driving circuit 50 even when the input voltage varies.

This will increase the efficiency of the light source driving circuit 50. This, in turn, will reduce the power consumption by the portable device 1. Further, if the built-in battery 20 is used to use the portable device 1, it can be used for a longer period of time.

Further, increasing the efficiency of the light source driving circuit 50 will prevent the light source driving circuit 50 from heating up. When the resolution of the liquid crystal display panel 31 is relatively high (for example, at the level of full high-definition or higher), it is difficult to use conventional techniques to mount a light source driving circuit 50 on a control board 33; thus, conventionally, a light source driving circuit 50 is mounted on a mother board 40 (FIG. 1). In the present embodiment, the light source driving circuit 50 can be prevented from heating up, allowing the light source driving circuit 50 to be mounted on the control board 33 (FIG. 2). This will improve the integrity of the LCD module 30.

The first embodiment of the present invention has been described. In the above description, the signal generating circuit 60 receives, from the signal selecting switch K, a signal S related to the power supply being selected, and generates signals Pa, Pb and Pc based on the signal S to control the switch groups S1, S2 and S3. However, the control of the switch groups S1, S2 and S3 is not limited to this method.

For example, the signal generating circuit 60 may receive a signal related to the value of an input voltage from the AC adaptor 10, built-in battery 20, light source driving circuit 50 or the like, and, based on this signal, generate signals Pa, Pb and Pc. In other words, the connection state of FIG. 3 may be established when the input voltage supplied to the light source driving circuit 50 is not lower than a predetermined threshold, and the connection state of FIG. 10 may be established when the input voltage is lower than the predetermined threshold.

Alternatively, the switch groups S1, S2 and S3 may be physical switches that can be manually operated. For example, the switch groups S1, S2 and S3 may be implemented as a jumper group composed a plurality of jumper switches.

### Example Variation 1 of First Embodiment

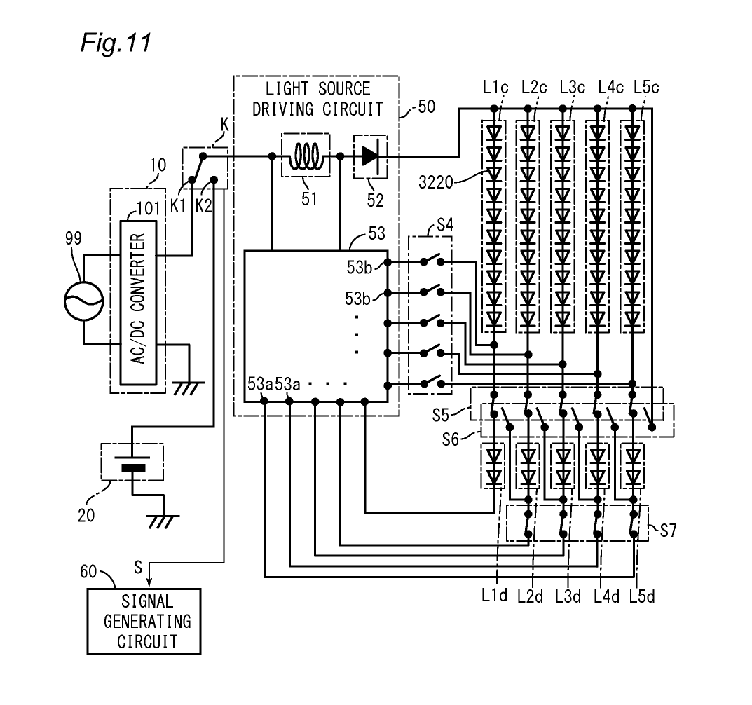

FIG. 11 is an equivalent circuit schematic of those of the components of a portable device including a backlight device in an example variation of the first embodiment of the present invention that are involved in lighting of the light source. The portable device of the present example variation is different from the portable device 1 of the first embodiment in the configuration of light-emitting element columns and switch groups.

The portable device in the present example variation includes, instead of the light-emitting element columns L1a, L2a, . . . , and L5a, light-emitting element columns L1c, L2c, . . . , and L5c each including ten light-emitting elements 3220. Further, the portable device includes, instead of the light-emitting element columns L1b, L2b, . . . , and L5b, light-emitting element columns L1d, L2d, . . . , and L5d each including two light-emitting elements 3220. That is, while the twelve light-emitting elements 3220 of the portable device 1 are divided into 6:6, the twelve light-emitting elements 3220 of the present example variation are divided into 10:2.

The portable device in the present example variation includes switch groups S4, S5, S6 and S7 instead of the switch groups S1, S2 and S3. The portable device in the present example variation also adjusts the voltage in loads by switching the switch groups S4, S5, S6 and S7 between different connection states.

FIG. 11 shows one connection state of the switch groups S4, S5, S6 and S7 of the portable device in the present example variation. In this connection state, all the switches of the switch group S4 are off, all the switches of the switch group S5 are on, all the switches of the switch group S6 are off, and all the switches of the switch group S7 are on.

Thus, the light-emitting element column L1c and light-emitting element column L1d are in series and connected with the light source driving circuit 50. Similarly, the light-emitting element column L2c and light-emitting element column L2d in series, the light-emitting element column L3c and light-emitting element column L3d in series, the light-emitting element column L4c and light-emitting element column L4d in series, and the light-emitting element column L5c and light-emitting element column L5d in series are connected with the light source driving circuit 50.

That is, in FIG. 11, five light-emitting element columns each composed of twelve light-emitting elements 3220 are in parallel and connected with the light source driving circuit 50.

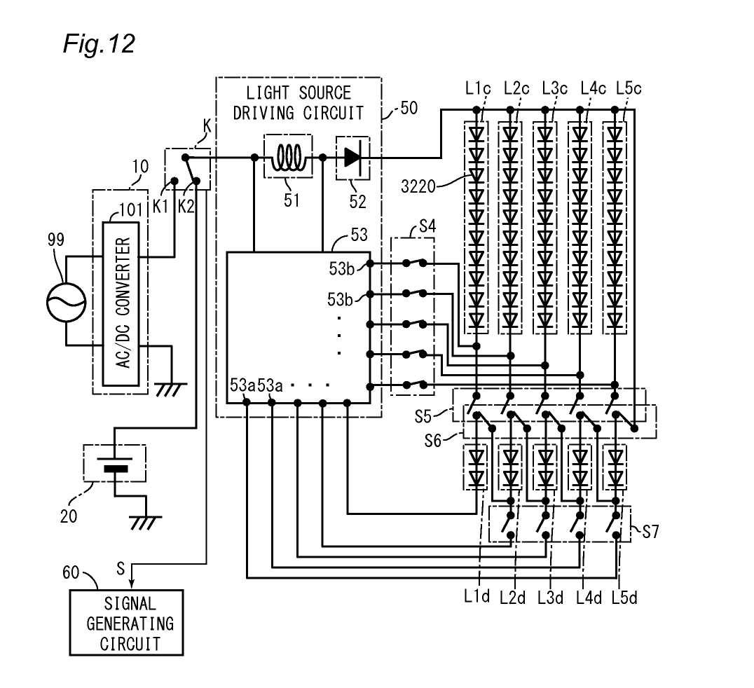

FIG. 12 shows another connection state of the switch groups S4, S5, S6 and S7 of the portable device in the present example variation. In this connection state, all the switches of the switch group S4 are on, all the switches of the switch group S5 are off, all the switches of the switch group S6 are on, and all the switches of the switch group S7 are off.

Thus, the light-emitting element columns L1c to L5c are in parallel and connected with the light source driving circuit 50. On the other hand, the light-emitting element columns L1d to L5d are in series and connected with the light source driving circuit 50.

That is, in FIG. 12, six light-emitting element columns each composed of ten light-emitting elements 3220 are in parallel and connected with the light source driving circuit 50.

A comparison between FIGS. 11 and 12 shows that the ratio between the voltages required to drive the light-emitting element columns in these connection states is 12:10.

Thus, the present example variation also adjusts the voltage required to light the light-emitting element columns by switching the configuration of the light-emitting element columns which form loads. As illustrated by the present example variation, the value of the output voltage can be decided using an appropriate arrangement of light-emitting element columns and switch groups. Thus, an arrangement of light-emitting element columns and switch groups may be decided on depending on the ratio between the voltage from the AC adaptor 10 and the voltage from the built-in battery 20.

### Example Variation 2 of First Embodiment

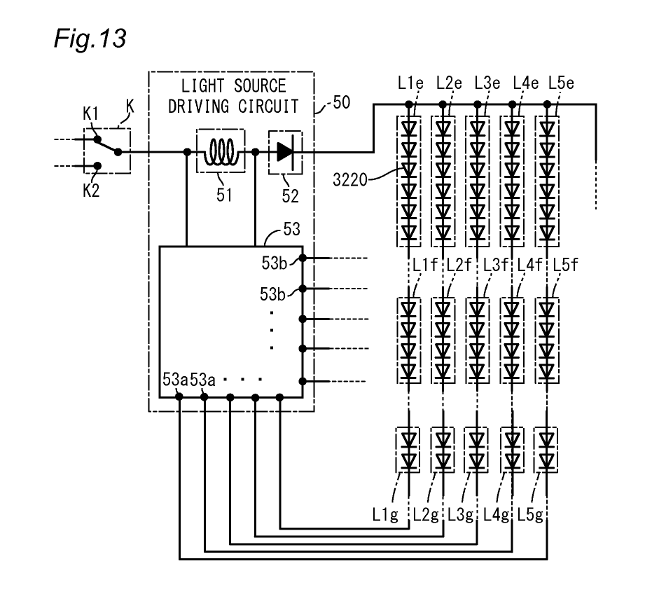

FIG. 13 is an equivalent circuit schematic of those of the components of a portable device including a backlight device in another example variation of the first embodiment of the present invention that are involved in lighting of the light source. The portable device of the present example variation is different from the portable device 1 of the first embodiment in the configuration of light-emitting element columns and switch groups.

The portable device in the present example variation includes, instead of the light-emitting element columns L1a, L2, . . . , and L5a and light-emitting element columns L1b, L2b, . . . , L5b, light-emitting element columns L1e, L2e, . . . , and L5e each including six light-emitting elements 3220, light-emitting element columns L1f, L2f, . . . , and L5f each including four light-emitting elements 3220, and light-emitting element columns L1g, L2b, . . . , and L5g each including two light-emitting elements 3220. That is, while the twelve light-emitting elements 3220 of the portable device 1 are divided into 6:6, the twelve light-emitting elements 3220 of the present example variation are divided into 6:4:2.

Switch groups are positioned between the light-emitting element columns L1e to L5e, light-emitting element columns L1f to L5f and light-emitting element columns L1g to L5g, and the light source driving circuit 50, to switch their electrical connection between different states. In FIG. 13, the switch groups are suggested by “ . . . ” and their configuration is not shown in detail. The portable device in the present example variation also adjusts the load voltage by switching the switch groups between different connection states.

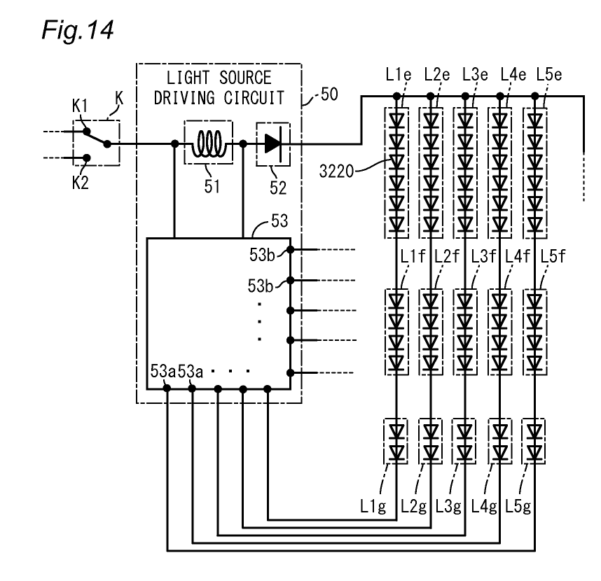

FIG. 14 illustrates one connection state of the switch groups of the portable device in the present example variation. In FIG. 14, the light-emitting element columns L1e, L1f and L1g are in series and connected with the light source driving circuit 50. Similarly, the light-emitting element columns L2e, L2f and L2g in series, the light-emitting element columns L3e, L3f and L3g in series, the light-emitting element columns L4e, L4f and L4g in series, and the light-emitting element columns L5e, L5f and L5g in series are connected with the light source driving circuit 50.

That is, in FIG. 14, five light-emitting element columns each composed of twelve light-emitting elements 3220 are in parallel and connected with the light source driving circuit 50.

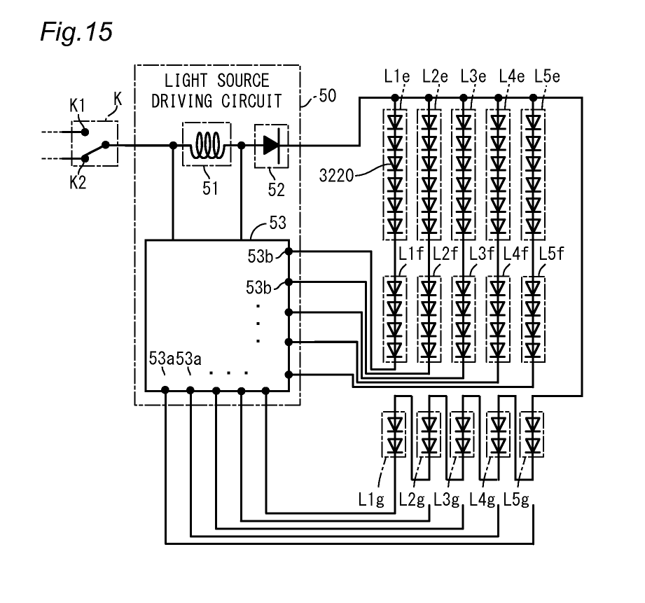

FIG. 15 illustrates another connection state of the switch groups of the portable device in the present example variation. In FIG. 15, the light-emitting element columns L1e and L1f in series, L2e and L2f in series, L3e and L3f in series, L4e and L4f in series, and L5e and L5f in series are connected with the light source driving circuit 50. Further, the light-emitting element columns L1g to L5g are in series and connected with the light source driving circuit 50.

That is, in FIG. 15, six light-emitting element columns each composed of ten light-emitting elements 3220 are in parallel and connected with the light source driving circuit 50.

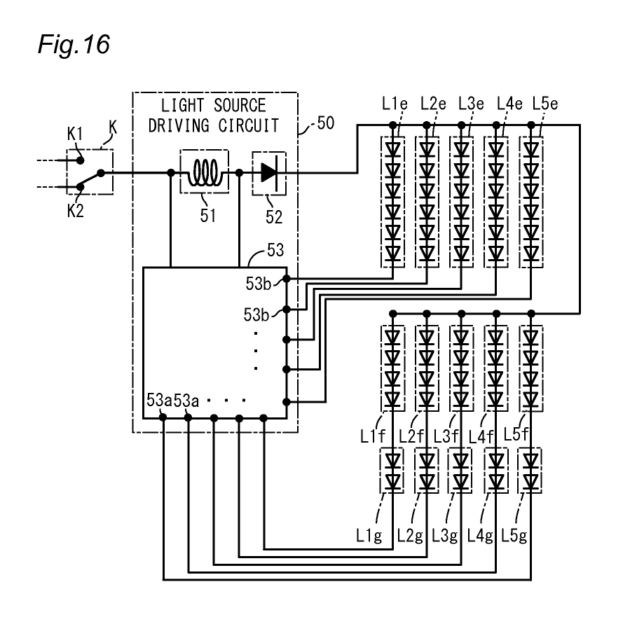

FIG. 16 illustrates yet another connection state of the switch groups of the portable device in the present example variation. In FIG. 16, the light-emitting element columns L1e to L5e are in parallel and connected with the light source driving circuit 50. Further, the light-emitting element columns L1f and L1g in series, L2f and L2g in series, L3f and L3g in series, L4f and L4g in series, and L5f and L5g in series are connected with the light source driving circuit 50.

That is, in FIG. 16, ten light-emitting element columns each composed of six light-emitting elements 3220 are in parallel and connected with the light source driving circuit 50.

A comparison between FIGS. 14, 15 and 16 shows that the ratio between the voltages required to drive the light-emitting element columns in these connection states is 12:10:6.

Thus, the present example variation also adjusts the voltage required to light light-emitting element columns by switching the configuration of light-emitting element columns which form loads. As illustrated in the present example variation, the configuration may be switched between three or more connection states.

### Second Embodiment

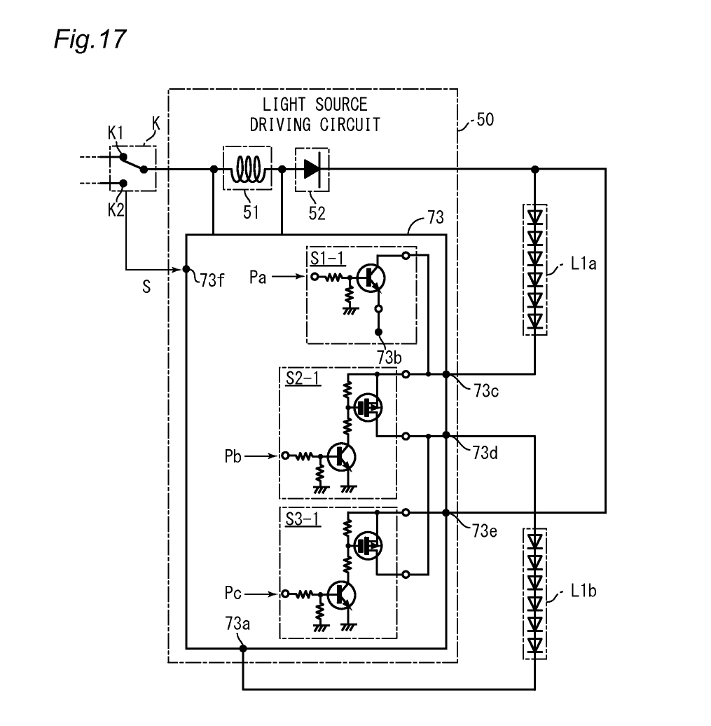

FIG. 17 is an equivalent circuit schematic of those of the components of a portable device including a backlight device in a second embodiment of the present invention that are involved in lighting of the light source. For ease, FIG. 17 only shows two light-emitting element columns (i.e. light-emitting element columns L1a and L1b) and only switches S1-1, S2-1 and S3-1 from the switch groups S1, S2 and S3; however, any number of these components may be used.

The portable device in the present embodiment includes a switching IC 73 instead of the switching IC 53. The switching IC 73 incorporates switch groups. That is, in the present embodiment, the functions of the switching IC 53 and the functions of the switch groups S1, S2 and S3 are integrated into the switching IC 73.

The switching IC 73 includes terminals 73a, 73c, 73d, 73e and 73f, and an inner terminal 73b. The cathode of the light-emitting element column L1b is connected with the terminal 73a. One contact of the switch S1-1 (i.e. emitter of the transistor of the switch S1-1 in the example of FIG. 17) is connected with the inner terminal 73b. The switching IC 73 ensures that the currents flowing through the loads connected with the terminal 73a and inner terminal 73b are constant.

The cathode of the light-emitting element column L1a is connected with the terminal 73c. The terminal 73c is connected with the other contact of the switch S1-1 and one contact of the switch S2-1. The anode of the light-emitting element column L1b is connected with the terminal 73d. The terminal 73d is connected with the other contact of the switch S2-1 and one contact of the switch S3-1. The cathode of the rectifier 52 is connected with the terminal 73e. The terminal 73e is connected with the other contact of the switch S3-1.

The power supply selecting switch K supplies the terminal 73f with a signal S related to the power supply being selected. Based on the signal S, the switching IC 73 generates, in its interior, a signal Pa for controlling the switch S1-1, a signal Pb for controlling the switch S2-2 and a signal Pc for controlling the switch S3-3. Alternatively, the signals Pa, Pb and Pc may be generated outside the switching IC 73.

The present embodiment reduces the number of components, reducing the size of the circuit.

### Third Embodiment

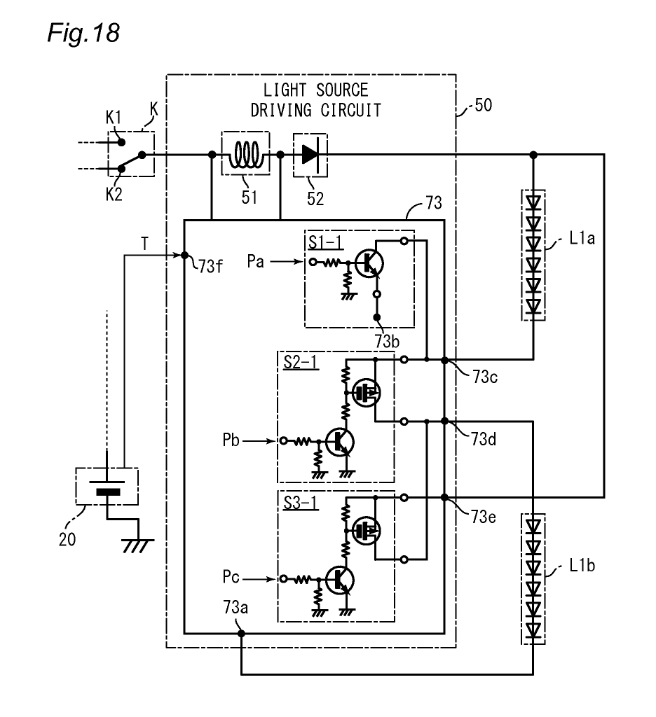

FIG. 18 is an equivalent circuit schematic of those of the components of a portable device including a backlight device in a third embodiment of the present invention that are involved in lighting of the light source. The present embodiment is different from the second embodiment in the operation of the switching IC 73.

In the present embodiment, the built-in battery 20 supplies the switching IC 73 with a signal T related to an input voltage. Based on the signal T, the switching IC 73 generates, in its interior, a signal Pa for controlling the switch S1-1, a signal Pb for controlling the switch S2-2 and a signal Pc for controlling the switch S3-3. More specifically, the connection state of the switches S1-1 to S3-1 is changed depending on whether the voltage supplied by the built-in battery 20 is not less than a predetermined value or it is less than the predetermined value.

The present embodiment switches the configuration of loads depending on how much the battery 20 has been drained. This will increase the efficiency of the light source driving circuit 50, increasing the period of time for which the battery 20 can be used. Or, even when the battery 20 has been drained to such a degree that the portable device cannot be used anymore, the configuration of loads may be switched to allow it to be used again. This advantage may be used as an emergency use mode in the portable device, for example.

### Other Embodiments

Although embodiments of the present invention have been described, the present invention is not limited to the above embodiments, and various modification are possible within the scope of the invention. Further, some or all of the embodiments may be combined as appropriate and carried out.

### INDUSTRIAL APPLICABILITY

The present invention is industrially useful as a backlight device.

1. A backlight device comprising:
a converter circuit;
a first light-emitting element column and a second light-emitting element column each including one or more light-emitting elements connected in series; and
a group of switches configured to control electrical connection between the converter circuit, the first light-emitting element column and the second light-emitting element column,
wherein the group of switches are switched between a plurality of connection states including a first connection state in which the first light-emitting element column and the second light-emitting element column are in series and connected with the converter circuit and a second connection state in which the first light-emitting element column and the second light-emitting element column are in parallel and connected with the converter circuit.

2. The backlight device according to claim 1, further comprising: a signal generating circuit configured to receive a signal related to a value of an input voltage supplied to the converter circuit, and switch the group of switches to the first connection state when the input voltage is not lower than a predetermined value, and switch the group of switches to the second connection state when the input voltage is lower than the predetermined value.

3. The backlight device according to claim 1, further comprising: a signal generating circuit configured to receive a signal related to a type of a power supply supplying power to the converter circuit, and switch the group of switches between the first connection state and the second connection state depending on the type of the power supply.

4. The backlight device according to claim 3, wherein the signal generating circuit switches the group of switches to the first connection state when the type of the power supply is external power supply and switch the group of switches to the second connection state when the type of the power supply is battery.

5. The backlight device according to claim 1, wherein a number of the light-emitting elements included in the first light-emitting element column is equal to a number of the light-emitting elements included in the second light-emitting element column.

6. The backlight device according to claim 1, wherein a number of the light-emitting elements included in the first light-emitting element column is different from a number of the light-emitting elements included in the second light-emitting element column.

7. The backlight device according to claim 1, further comprising: a third light-emitting element column including one or more light-emitting elements connected in series,
wherein, in the first connection state, the group of switches connect the first light-emitting element column, the second light-emitting element column and the third light-emitting element column in series and with the converter circuit.
